(19) United States
(12) Patent Application Publication
(10) Pub. No.: US 2024/0229728 A1
(43) Pub. Date: Jul. 11, 2024

(54) Engine Control By Lock Change Files

(71) Applicant: Peter Gregory Haiping Hwang, San Marcos, TX (US)

(72) Inventor: Peter Gregory Haiping Hwang, San Marcos, TX (US)

(21) Appl. No.: 18/150,794

(22) Filed: Jan. 6, 2023

(51) Int. Cl. F02D 11/10; F02D 25/02

(52) U.S. Cl. CPC F02D 11/106; F02D 25/02

(57) ABSTRACT

A system controls engine power by self-executing contracts with an authority. A distributed method is performed at a plurality of authority apparatus, power level lock change file servers, and engine control units. Each authority apparatus provides a policy object for each Engine Control Unit (ECU). An authority sets power levels for self-executing compliance with policy constraints. A power level lock change file (LockChangeFile) server checks against date time constraints and geo-location scope by its authorities. An ECU receives a power level token when time and location constraint(s) by at least one authority is within scope. A distributed method includes receiving space time constraints and determining a policy object and Authoritative LockChangeFile; receiving date, time, and location indicia from an ECU; determining the lowest power level consistent with the LockChangeFile; and requesting a new power level token by transmitting an identity credential, time and location indicia when needed.

### CROSS-REFERENCE TO RELATED APPLICATIONS

The present application is a US non-provisional patent application of a provisional patent application Ser. No. 63/436,565 filed 2022 Dec. 31 titled “PowerGated LockChangeFile” which is incorporated by reference in its entirety and benefits from its Receipt Date 31 Dec. 2022.

### PRIOR ART

As is known, public key cryptography enables self-verifying authentication. As is known content addressable storage is commercially available based on hashes of the data. As is known, date, time, and location information can be obtained from terrestrial cellular telephone base stations, satellite navigation services, celestial and inertial navigation systems, and from solid state clocks and accelerometers.

### BACKGROUND OF THE INVENTION

As is known, modern electrical and internal combustion motors used for transportation depend on engine control units to adapt to load and environmental condition for optimum performance and efficiency. However, maintenance and inspection schedules are more what you might call a goal or guideline. What is needed is a way to enforce contractual agreements for maintenance, recalls, insurance policies, leasing terms, licensing, and restrictions on geo-location on engines that have inherent independence of mobility in time and in space.

### SUMMARY OF THE INVENTION

A system provides engine power control by a lock control file governed by self-executing contracts with at least one authority.

The system includes a distributed method performed at
a plurality of authority apparatus,
a plurality of power lock change file servers,
a plurality of engine control units, and
a network.

Each authority apparatus provides an authority policy object which is a component of a power level lock change file for each engine control unit. The files and their component objects are stored in distributed media for redundancy and availability through network communications. The power level lock change file most recently computed by any authority server includes links to each previous version of the power level lock change file and is Authoritative with respect to its engine control unit.

An authority console enables setting of power levels according to time and location for self-executing compliance with constraints including insurance policies, maintenance and recall policies, financial terms and conditions, ownership, and restriction to geo-location policies.

In an embodiment, power level lock change files include a plurality of objects stored in content addressable media according to their hash.

In an embodiment, a hierarchical object locator provides improved performance in retrieving distributed objects which are addressable by hashed content by dynamically determining the access method with least latency at that time to the Authoritative power level lock change file and its component authority policy objects.

A power level lock change file server determines a power level token for an engine control unit when its time and location indicia is checked against the space time constraints established by its authorities. A power level lock change file is generated including a hierarchical object linking to its previous power level lock change file version and a hierarchical object linking to each authority which has a self-executing policy object for the time and location of the engine control unit.

The lowest power level agreed among the authorities may only be for test, or for transit to inspection or maintenance or for acceleration and climb for the reported time and location.

In an embodiment, a multi-engine configuration may receive a joint power level token causing yaw away from a sensitive location when approaching a geo-location boundary.

An engine control unit determines a power level from its time and location according to a power level token. A power level token is received from a power level lock change server when time and location constraint(s) by at least one authority is within scope.

The power level token is received from a power level lock change file server whenever the engine control unit provides its authenticated time and location indicia.

The distributed method includes
Receiving space time constraints from each authority for each engine control unit and determining a policy object and Authoritative power level lock change file;
Determining an access method for least latency to the Authoritative power level lock change file and its component objects;
Receiving time and location indicia from an engine control unit; Determining the lowest power level consistent with the Authoritative power level lock change file;
Generating and transmitting a power level token to the engine control unit;
Determining time and location at an engine control unit;
Applying a power level permitted by a stored power level token on the condition that the power level lock change file in store is still Authoritative;
Requesting a new power level token by transmitting an identity credential, time and location indicia in a request; and
Displaying messages to engine operator and to authority official when a power level is changed, an action is required, or a time and location are out of compliance.

### BRIEF DESCRIPTION OF DRAWINGS

To further clarify the above and other advantages and features of the present invention, a more particular description of the invention will be rendered by reference to specific embodiments thereof that are illustrated in the appended drawings. Like reference numbers and designations in the various drawings indicate like elements. For purposes of clarity, not every component may be labeled in every drawing. It is appreciated that these drawings depict only typical embodiments of the invention and are therefore not to be considered limiting of its scope. The invention will be described and explained with additional specificity and detail through the use of the accompanying drawings in which:

FIGS. 1-4 disclose exemplary embodiments of processors and computing environments which enable performance of methods. FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating a cloud computing environment in which illustrative embodiments may be implemented;

FIG. 4 is a diagram illustrating an example of abstraction layers of a cloud computing environment in accordance with an illustrative embodiment;

FIG. 5 is a block diagram of a control system for engine power level by authorities.

FIG. 6 is a block diagram of an authority server for constraining power levels.

FIG. 7 is a block diagram of a power level lock change file server coupled to an authority server.

FIG. 8 is a block diagram of an engine control unit coupled to a power level lock change file server.

FIG. 9 is a flow chart of a method at an authority apparatus.

FIG. 10 is a flow chart of a method at a power level lock change file server.

FIG. 11 is a flow chart of a method at an engine control unit.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

The invention includes
a plurality of authority apparatus, a plurality of power lock change file servers, a plurality of engine control units, and a network.

The invention includes distributed methods performed among the authority apparatuses, the power level lock change file server, and the engine control units which transform time and location indicia data into power levels emitted by engines including: Receiving date time and location constraints and determining a policy object and Authoritative LockChangeFile;
Receiving date, time, and location indicia from an ECU;
Determining the lowest power level consistent with the LockChangeFile;
Requesting a new power level token by transmitting an identity credential, time and location indicia when needed.

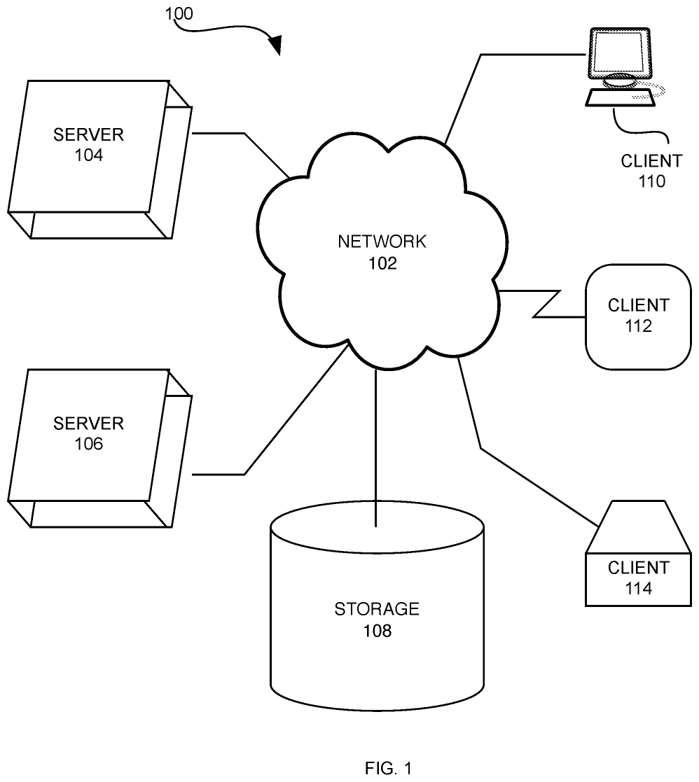

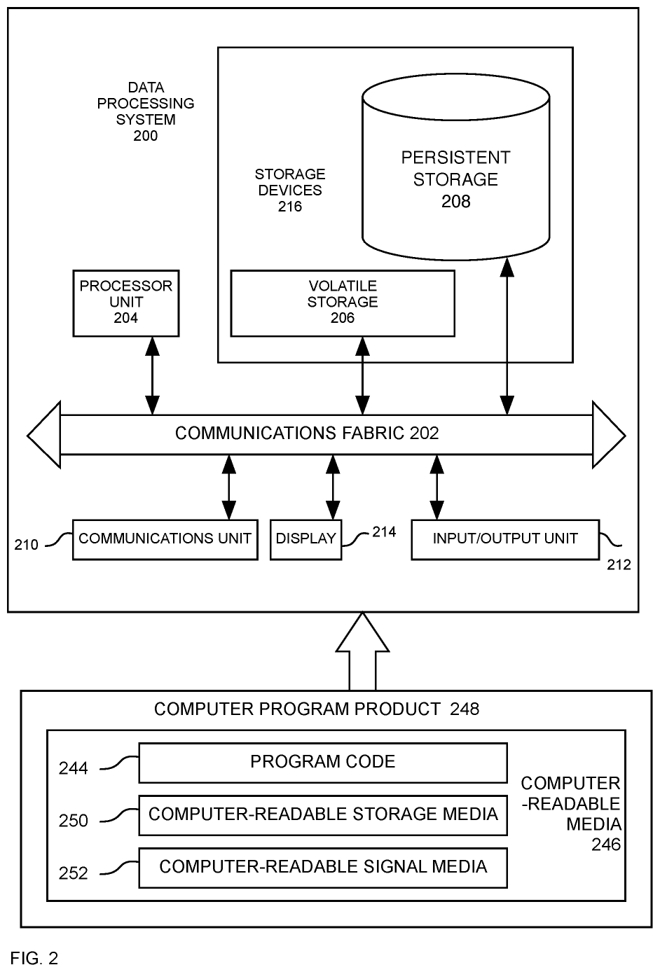

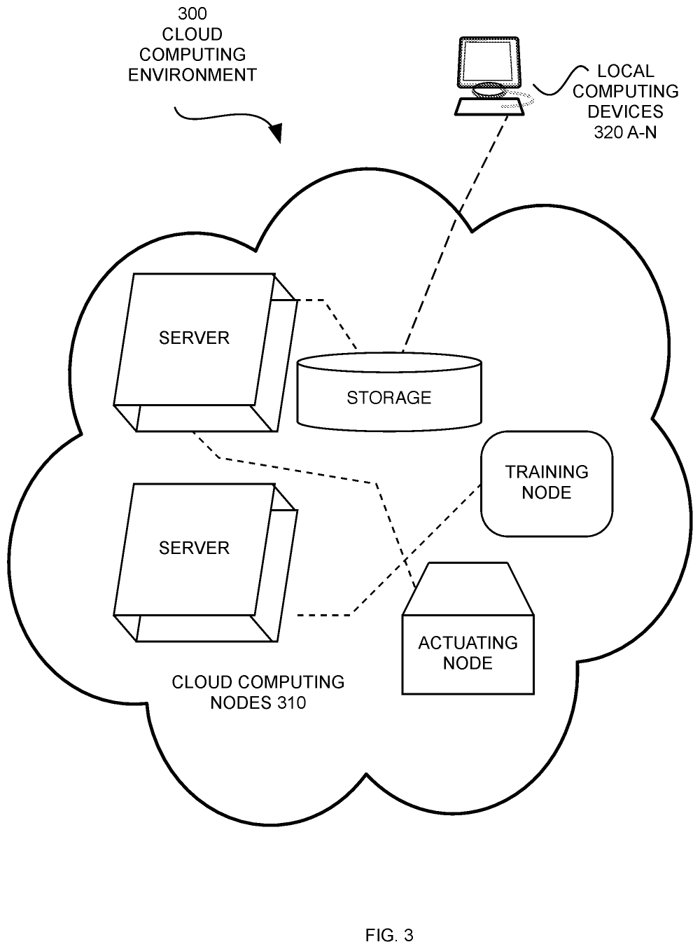

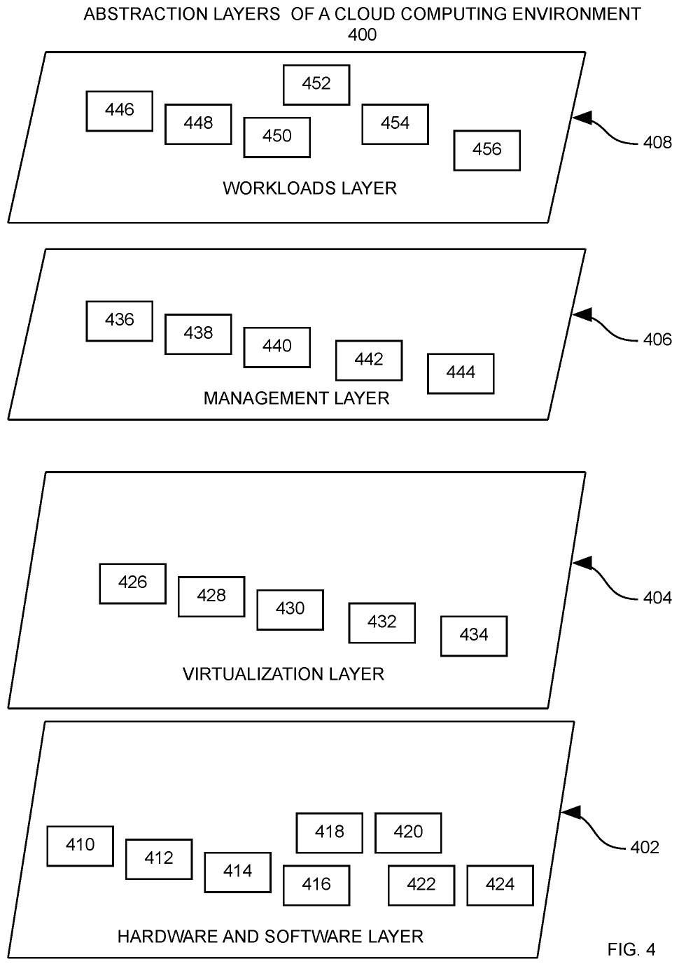

Referring now to the Figures, FIGS. 1-4 disclose exemplary embodiments of processors and computing environments which enable performance of methods. FIG. 1 is a pictorial representation of a network of data processing systems in which illustrative embodiments may be implemented; FIG. 2 is a diagram of a data processing system in which illustrative embodiments may be implemented; FIG. 3 is a diagram illustrating a cloud computing environment in which illustrative embodiments may be implemented; FIG. 4 is a diagram illustrating an example of abstraction layers of a cloud computing environment in accordance with an illustrative embodiment;

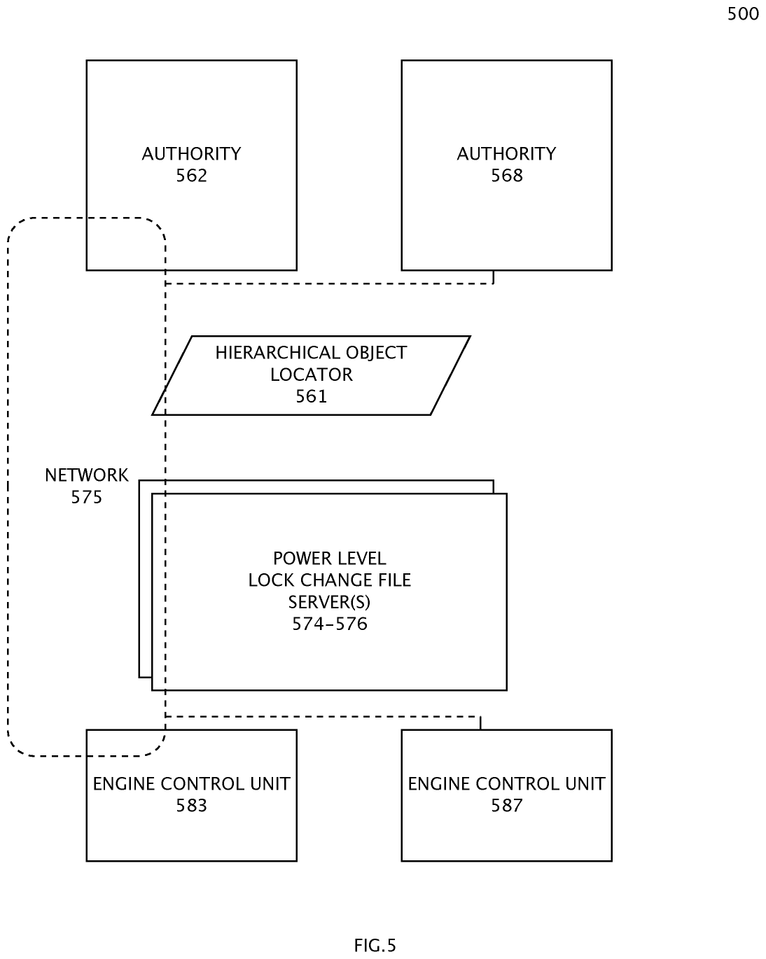

FIG. 5 is a block diagram of a control system for engine power level by authorities. A system 500 includes:

a plurality of authority servers 560,
a plurality of power level lock change file servers 574-576,
a plurality of engine control units 583-587,
a network 575 communicatively coupling the above subsystems, and in an embodiment, further including a hierarchical object locator 561.

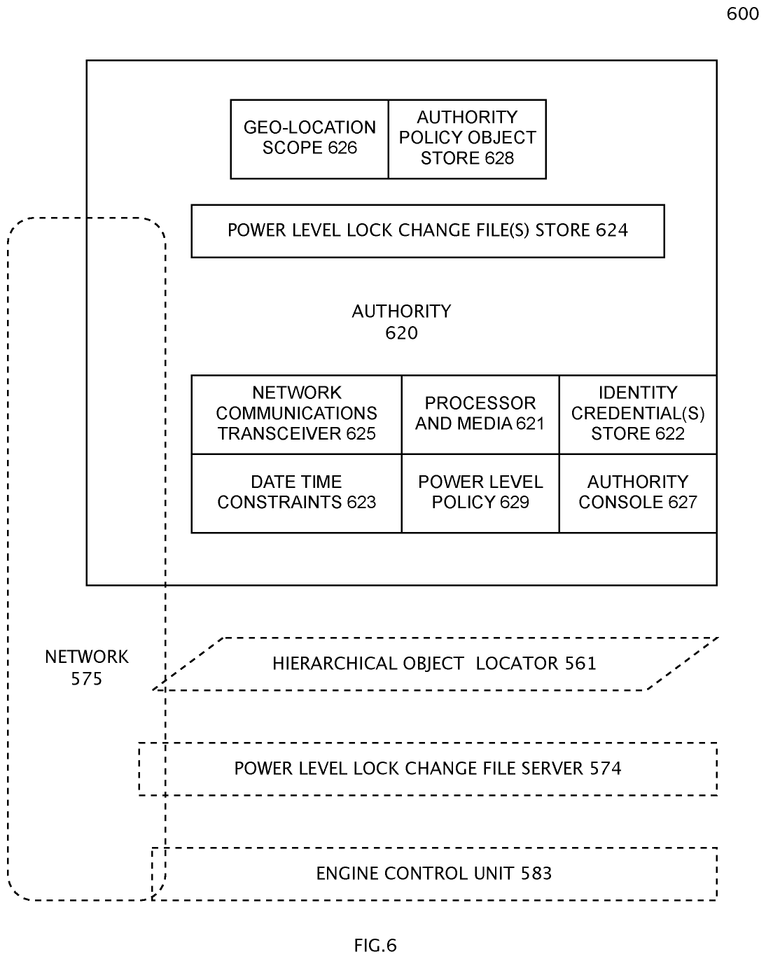

FIG. 6 is a block diagram of authority server 600. An exemplary authority server 620 includes
A processor and media module 621;
An identity credential 622;
A date time constraint module 623;
A power level lock change file(s) store 624;
A network communication transceiver 625;
A geo-location scope module 626;
An authority console 627;
A power level policy module 629, and in an embodiment, further including an authority
policy object store 628;
All 621-628 mutually coupled.

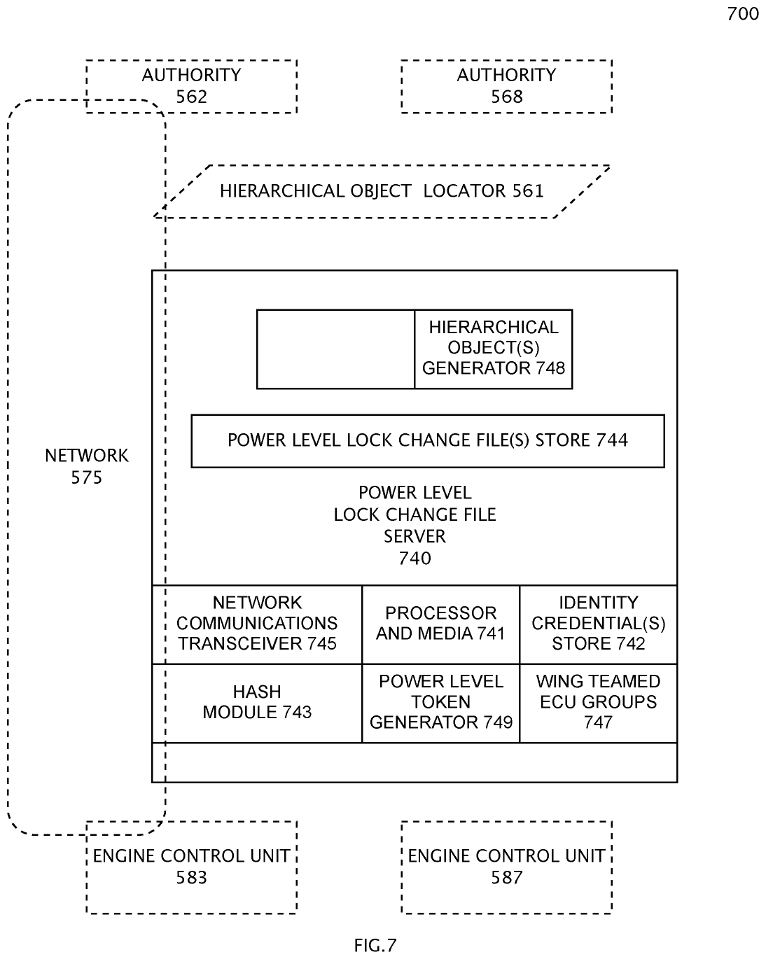

FIG. 7 is a block diagram of a power level lock change file server 700. An exemplary power level lock change file server 740 includes
A processor and media module 741,
An identity credential(s) store 742,
A hash module 743,
A power level lock change file(s) store 744,
A network communication transceiver 745,
A winged team ECU groups store 747;
A power level token generator 749, and in an embodiment, further including an hierarchical object(s) generator 748,
All mutually coupled.

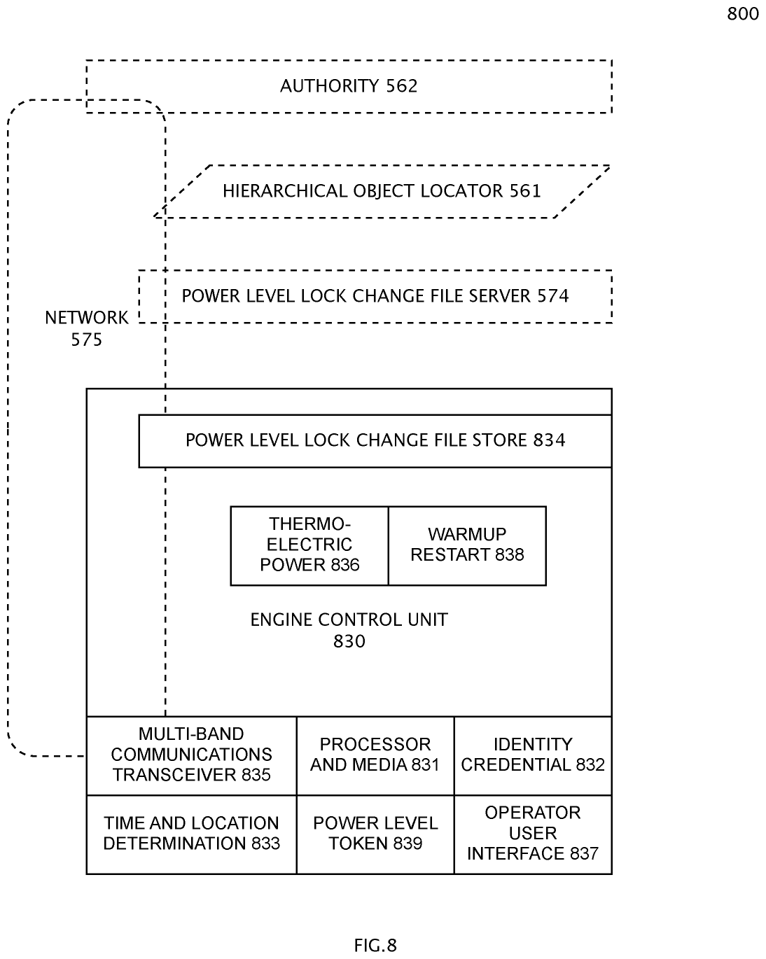

FIG. 8 is a block diagram of an engine control unit 800. An exemplary engine control unit 830 includes
A processor and media module 831,
An identity credential 832,
A time and location determination module 833,
A power level lock change file store 834,
A multi-band communication transceiver 835,
An operator user interface 837;
A power level token store 839, and in an embodiment,
And further including a thermo-electric power module 836, and in an embodiment, further including a warmup restart module 838,
All mutually coupled.

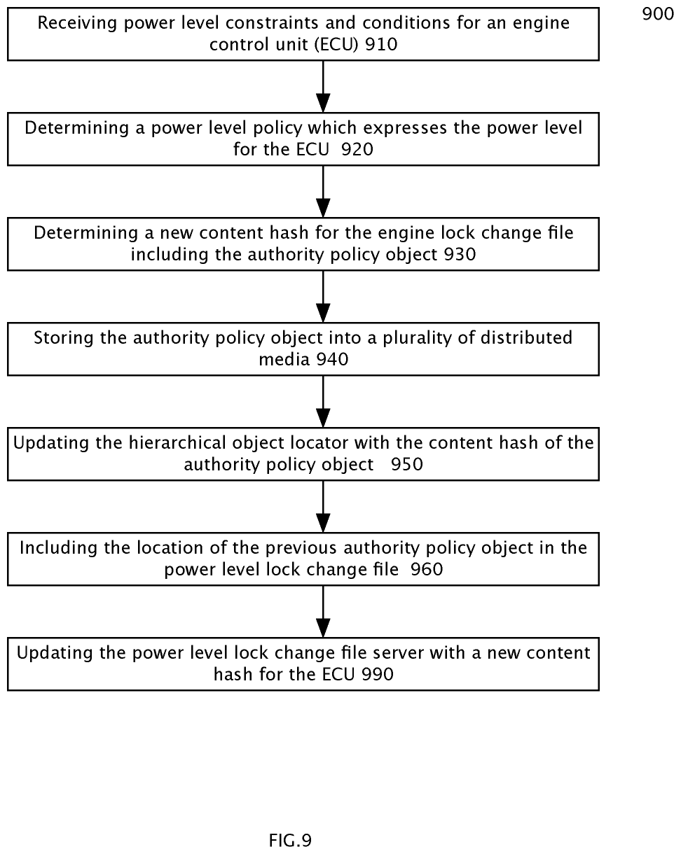

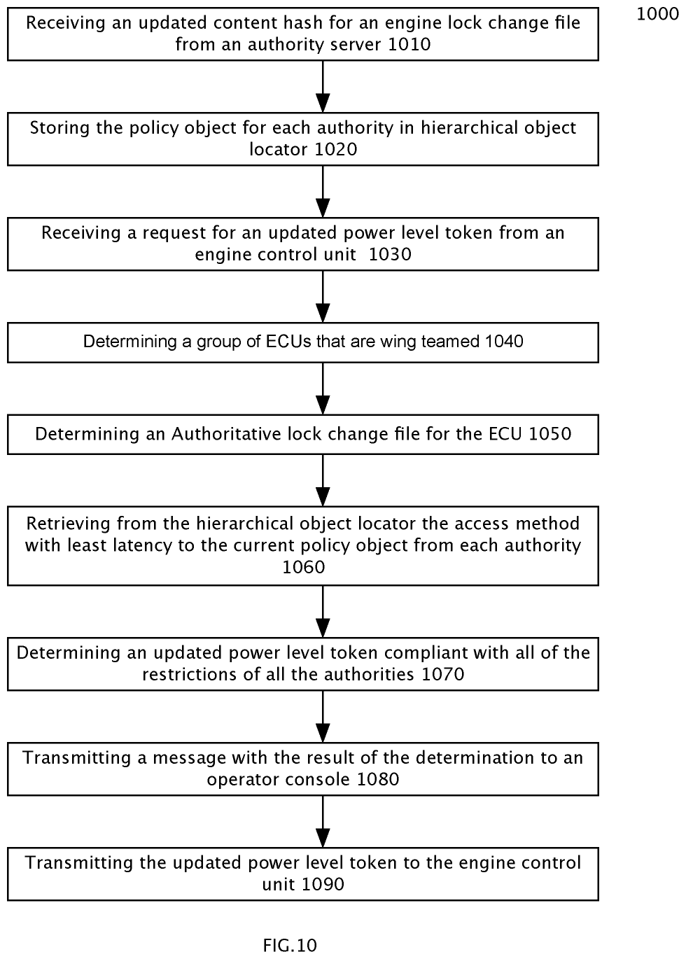

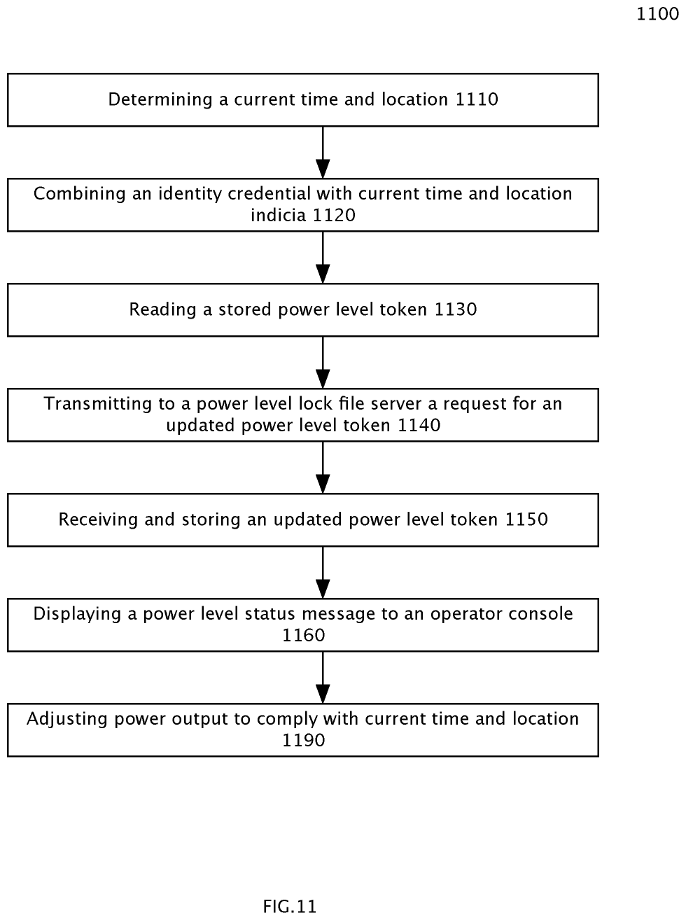

FIGS. 9-11 illustrate exemplary flow charts of methods distributed among the authority apparatuses, the power level lock change file server, and the engine control units which transform time and location indicia data into power levels emitted by engines including: Receiving space time constraints and determining a policy object and Authoritative LockChangeFile;
Receiving date, time, and location indicia from an ECU;
Determining the lowest power level consistent with the LockChangeFile;
Requesting a new power level token by transmitting an identity credential, time and location indicia when needed. The references are related to the exemplary embodiments below.

One aspect of the invention is illustrated as an engine power control system 500 including:
A plurality of authority apparatuses 562-568;
A plurality of Engine Control Units 583-587; and
A plurality of power level lock change file servers 574-576; and a Network 575 communicatively coupling all the apparatuses.

In an embodiment, the system also includes: at least one hierarchical object locator 561 whereby content addressable file objects are retrievable by an access method with least latency.

In an embodiment, the system also includes: at least one location and time determination service provider including but not limited to a global positioning service, a cellular radio service, a wi-fi network, a radio beacon service, a satellite navigation service, an inertial navigation service, and electric beacon navigation service.

In an embodiment, said authority apparatus 600 includes:
An authority policy object store 628 encoded by
An identity credential 622;
A range of date time constraints 623 for which the authority permits each engine power level;
A range of geo-location zones 626 within which the authority permits each engine power level;
An authentication by the authority;
A hash of the current power level lock change file;
A link to the location of supporting authority policy objects;
A message to be displayed when permission is denied; and
A link to a hash of each prior authority policy object and of each prior power level lock change file.

In an embodiment, said power level lock change file server 700 includes:
A network communication transceiver module 745 to receive power level requests from a first engine control unit and transmit power level tokens;
An authentication module to validate the identity credential transmitted from an engine control unit;
A hash module 743;
A store of power level Lock Change Files 744;
A module to determine the content addressable most recently computed Engine Lock Change File for the engine control unit stored by an Authority;

A module to retrieve each hierarchical object for the Engine Lock Change File from each Authority;
A store of wing teamed ecu groups 747;
A hierarchical object(s) generator 748;
A module to generate a power level token 749, by logically combining the policy objects of all Authorities and provide the power level token to the requesting ECU;
A module to transmit a message to an operator user interface with the result of determining a power level token. Such a message may indicate payments, inspections, or maintenance services are due. Power levels consistent with testing, or taxiing may be enabled for a limited time or distance.

In an embodiment, said plurality of authority apparatuses includes at least one maintenance policy whereby failure to log completion of scheduled service causes a power level to be lower than acceleration and climb for a location; a recall policy whereby at least one of a recall notice and failure to record it triggers a self-executing compliance a power level; and at least one of:
insurance policy, financial terms and conditions, ownership, and
licensing validation, and restriction to geo-location policies. Rather than contractual obligations for payments, inspections, and maintenance enforced by legal documents, the available power levels reflect the constraints embedded in self-executing objects.

In an embodiment, said plurality of authority servers also includes: a restricted geo-location boundary yaw activation geo-location scope 626 whereby power levels are overridden for engines within a glide range of a restricted geo-location.

In an embodiment, said engine control unit includes:
An identity credential 832;
A time and location determination module 833; and
A multi-band communications transceiver 835. The time and location determination module may operate internally or obtain reference data from satellites, cellular base stations, radio navigation or celestial navigation services.

In an embodiment, said engine control unit also includes:
A thermo-electric power module 836;
A power level token store 839; and
A power level lock change file store 834. The thermo-electric power module converts heat to electrical power for communications, determining time and location indicia, and transmitting a request for a power level token whenever the engine starts.

In an embodiment, said engine control unit also includes a warmup restart module 838;
A processor and media 831; and
An operator user interface 827.

Another aspect of the invention is a method of operation 900 for a system having the processes at an authority server:
Receiving power level constraints and conditions for an engine control unit (ECU) 910;
Determining a power level policy which expresses the power level for the ECU 920;
Determining a new content hash for the engine lock change file including the authority policy object 930;
Storing the authority policy object into a plurality of distributed media 940;
Updating the hierarchical object locator with the content hash of the authority policy object 950;
Including the location of the previous authority policy object in the power level lock change file 960; and,
Updating the power level lock change file server with a new content hash for the ECU 990.

In an embodiment the method also includes at a power level lock change file server,
Receiving an updated content hash for an engine lock change file from an authority server 1010;
Storing the policy object for each authority in hierarchical object locator 1020;
Receiving a request for an updated power level token from an engine control unit 1030;
Determining an Authoritative lock change file for the engine control unit 1050;
Retrieving from the hierarchical object locator the access method with least latency to the current policy object from each authority 1060;

Determining an updated power level token compliant with all of the restrictions of all the authorities 1070;
Transmitting a message with the result of the determination to an operator console 1080; and
Transmitting the updated power level token to the engine control unit 1090.

In an embodiment the method also includes
A process 1100 at an engine control unit,
Determining a current time and location 1110;
Combining an identity credential with current time and location indicia 1120;
Reading a stored power level token 1130;
Transmitting to a power level lock file server a request for an updated power level token 1140;
Receiving and storing an updated power level token 1150;
Displaying a power level status message to an operator console 1160; and
Adjusting power output to comply with current time and location 1190.

Another aspect of the invention is a plurality of engine control units 800 including: a first engine control unit 830 coupled to a portside engine and a second engine control unit coupled to a starboardside engine.

In an embodiment, the first engine control unit (ECU) includes:
A location and time determination module 833;
An identity credential module 832;
A multi-band communication transceiver 835; and
A power level token store 839.

In an embodiment, the first engine control unit (ECU) also includes:
A power level token decoder;
A power level output control valve: and
An interface to an operator console 837.

In an embodiment, the first engine control unit (ECU) also includes: An engine warmup restart module 838; A thermoelectric power generator 836: and A power level token request module.

In an embodiment, the second ECU includes a configuration store which distinguishes it as one of a port-side engine and a starboard-side engine whereby a joint power level token overrides the power level in at least one engine.

In an embodiment, the location and time determination module determines a vector of travel direction.

In an embodiment, the plurality of engine control units cause a yaw force by differential power output levels applied to the portside engine and to the starboardside engine until the vector of travel direction avoids inertia into a restriction in geo-location. Advantageously such a system provides a long-sought solution of a safety problem by causing any powered flight to steer away from an outer boundary of a restricted geo-location and any unpowered flight to lose momentum outside the inner sensitive area of a restricted geo-location.

In conclusion, the invention may be easily distinguished from simple on-off controls by its enabling power levels for test, taxi, and transit to service centers. The invention is distinguished by controlling by geo-location in addition to date and time. The invention is distinguished by robustness in distributed objects and servers vs centralized control. The invention is distinguished by initialization by engine heat and independence from external power. The invention is distinguished by potentially causing yaw when nearing the boundary of a restricted geo-location area which operates against coasting or gliding into a protected space during a sensitive time.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. A computer readable specification may be transformed into a specialized hardware processor such as for determining a hash, or a public-private key pair by a synthesis product configuring an IP core such as an ARM design architecture.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

With reference now to the figures, and in particular, with reference to FIGS. 1-4, diagrams of data processing environments are provided in which illustrative embodiments may be implemented. It should be appreciated that FIGS. 1-4 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables. Also, network 102 may be, for example, a private network, a public network, a hybrid network, a corporate network, or the like.

In the depicted example, server 104 and server 106 connect to network 102, along with storage 108. Server 104 and server 106 may be, for example, server computers with high-speed connections to network 102. Also, it should be noted that server 104 and server 106 may represent computing nodes in a cloud environment that manages analysis services for one or more networks and their respective resources. Alternatively, server 104 and server 106 may represent clusters of servers in a data center. Further, server 104 and server 106 may provide information, such as, for example, programs, application, updates, patches, and the like, to the registered client data processing systems.

Client 110, client 112, and client 114 also connect to network 102. In this example, client 110 is shown as desktop or personal computer with wire communication links to network 102. However, it should be noted that client 110 is an example only and may represent other types of data processing systems, such as, for example, a video stream capture, a hub, a credential scanner, an optical scanner, a radio transceiver, a bridge, a laptop computer, handheld computer, smart phone, smart watch, smart television, or the like, with wire or wireless communication links to network 102. A user of client 110 may utilize client 110 to access and utilize the resources and/or services provided by client 112 and client 114. Resources may include, for example, data, documents, software such applications and programs, hardware such as processors, memory, and storage, and the like. Services may include any type of online service, such as, for example, identity services, physical access control services, motor control, storage management, network optimization, version control, network latency reduction, banking services, financial services, governmental services, insurance services, entertainment services, search services, reservation services, and the like. In addition, it should be noted that client 110 may represent a plurality of different client devices corresponding to a plurality of different users.

Clients 112 and 114 are registered clients of server 104 and server 106. In this example, client 112 and client 114 each represents a data processing system, such as a sever computer, that provides the resources and services of network 102. Further, it should be noted that client 112 and client 114 may each represent a plurality of data processing systems corresponding to one or more organizations, enterprises, institutions, agencies, and the like.

Storage 108 is a network storage device capable of storing any type of data in a structured format or an unstructured format. In addition, storage 108 may represent a plurality of network storage devices. Further, storage 108 may store identifiers and network addresses for a plurality of different network security servers, identifiers, and network addresses for a plurality of different registered client devices, identifiers for a plurality of different users, and the like. Furthermore, storage unit 108 may store identities, IP and URL addresses, policies, and the like. Moreover, storage unit 108 may store other types of data, such as authentication or credential data that may include user names, passwords, images, and biometric data associated with network users, system administrators, and security analysts, for example.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on network security server 104 and downloaded to client 112 over network 102 for use on client 112.

In the depicted example, network data processing system 100 may be implemented as a number of different types of communication networks, such as, for example, the Internet, an intranet, a local area network, a wide area network, a telecommunications network, or any combination thereof. FIG. 1 is intended as an example only, and not as an architectural limitation for the different illustrative embodiments.

With reference now to FIG. 2, a diagram of a data processing system is depicted in accordance with an illustrative embodiment. Data processing system 200 is an example of a computer, such as server 104 in FIG. 1, in which computer readable program code or instructions implementing processes of illustrative embodiments may be located. In this illustrative example, data processing system 200 includes communications fabric 202, which provides communications between processor unit 204, volatile storage 206, persistent storage 208, communications unit 210, input/output unit 212, and display 214.

Processor unit 204 serves to execute instructions for software applications and programs that may be loaded into volatile storage 206. Processor unit 204 may be a set of one or more hardware processor devices or may be a multi-core processor, depending on the particular implementation.

Volatile storage 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Volatile storage 206, in these examples, may be, for example, a random-access memory, or any other suitable non-transitory storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into volatile storage 206 for running by processor unit 204. The processes of the different embodiments may be performed by processor unit 204 using computer-implemented instructions, which may be located in a memory apparatus, such as volatile storage 206. These program instructions are referred to as program code, computer usable program code, or computer readable program code that may be read and run by a processor in processor unit 204. The program instructions, in the different embodiments, may be embodied on different physical computer readable storage devices, such as volatile storage 206 or persistent storage 208.

Program code 244 is located in a functional form on computer readable media 246 that is selectively removable and may be loaded onto or transferred to data processing system 200 for running by processor unit 204. Program code 244 and computer readable media 246 form computer program product 248. In one example, computer readable media 246 may be computer readable storage media 250 or computer readable signal media 252. Computer readable storage media 250 may include, for example, an optical or magnetic disc that is inserted or placed into a drive or other device that is part of persistent storage 208 for transfer onto a storage device, such as a hard drive, that is part of persistent storage 208. Computer readable storage media 250 also may take the form of a persistent storage, such as a hard drive, a thumb drive, or a flash memory that is connected to data processing system 200. In some instances, computer readable storage media 250 may not be removable from data processing system 200.

Alternatively, program code 244 may be transferred to data processing system 200 using computer readable signal media 252. Computer readable signal media 252 may be, for example, a propagated data signal containing program code 244. For example, computer readable signal media 252 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 244 may be downloaded over a network to persistent storage 208 from another device or data processing system through computer readable signal media 252 for use within data processing system 200. For instance, program code stored in a computer readable storage media in a data processing system may be downloaded over a network from the data processing system to data processing system 200. The data processing system providing program code 244 may be a server computer, a client computer, or some other device capable of storing and transmitting program code 244.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor or a molecular structure.

As another example, a computer readable storage device in data processing system 200 is any hardware apparatus that may store data. Volatile storage 206, persistent storage 208, and computer readable storage media 250 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, volatile storage 206 or a cache such as found in an interface and memory controller hub that may be present in communications fabric 202.

It is understood that although this disclosure includes a detailed description on cloud computing, implementation of the teachings recited herein are not limited to a cloud computing environment. Rather, illustrative embodiments are capable of being implemented in conjunction with any other type of computing environment now known or later developed. Cloud computing is a model of service delivery for enabling convenient, on-demand network access to a shared pool of configurable computing resources, such as, for example, networks, network bandwidth, servers, processing, memory, storage, applications, virtual machines, and services, which can be rapidly provisioned and released with minimal management effort or interaction with a provider of the service. This cloud model may include at least five characteristics, at least three service models, and at least four deployment models.

The characteristics may include, for example, on-demand self-service, broad network access, resource pooling, rapid elasticity, and measured service. On-demand self-service allows a cloud consumer to unilaterally provision computing capabilities, such as server time and network storage, as needed automatically without requiring human interaction with the service's provider. Broad network access provides for capabilities that are available over a network and accessed through standard mechanisms that promote use by heterogeneous thin or thick client platforms, such as, for example, mobile phones, laptops, and personal digital assistants. Resource pooling allows the provider's computing resources to be pooled to serve multiple consumers using a multi-tenant model, with different physical and virtual resources dynamically assigned and reassigned according to demand. There is a sense of location independence in that the consumer generally has no control or knowledge over the exact location of the provided resources, but may be able to specify location at a higher level of abstraction, such as, for example, country, state, or data center. Rapid elasticity provides for capabilities that can be rapidly and elastically provisioned, in some cases automatically, to quickly scale out and rapidly released to quickly scale in. To the consumer, the capabilities available for provisioning often appear to be unlimited and can be purchased in any quantity at any time. Measured service allows cloud systems to automatically control and optimize resource use by leveraging a metering capability at some level of abstraction appropriate to the type of service, such as, for example, storage, processing, bandwidth, and active user accounts. Resource usage can be monitored, controlled, and reported providing transparency for both the provider and consumer of the utilized service.

Service models may include, for example, Software as a Service (Saas), Platform as a Service (PaaS), and Infrastructure as a Service (laaS). Software as a Service is the capability provided to the consumer to use the provider's applications running on a cloud infrastructure. The applications are accessible from various client devices through a thin client interface, such as a web browser (e.g., web-based e-mail). The consumer does not manage or control the underlying cloud infrastructure including network, servers, operating systems, storage, or even individual application capabilities, with the possible exception of limited user-specific application configuration settings. Platform as a Service is the capability provided to the consumer to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service is the capability provided to the consumer to provision processing, storage, networks, and other fundamental computing resources where the consumer is able to deploy and run arbitrary software, which can include operating systems and applications. The consumer does not manage or control the underlying cloud infrastructure, but has control over operating systems, storage, deployed applications, and possibly limited control of select networking components, such as, for example, host firewalls.

Deployment models may include, for example, a private cloud, community cloud, public cloud, and hybrid cloud. A private cloud is a cloud infrastructure operated solely for an organization. The private cloud may be managed by the organization or a third party and may exist on-premises or off-premises. A community cloud is a cloud infrastructure shared by several organizations and supports a specific community that has shared concerns, such as, for example, mission, security requirements, policy, and compliance considerations. The community cloud may be managed by the organizations or a third party and may exist on-premises or off-premises. A public cloud is a cloud infrastructure made available to the general public or a large industry group and is owned by an organization selling cloud services. A hybrid cloud is a cloud infrastructure composed of two or more clouds, such as, for example, private, community, and public clouds, which remain as unique entities, but are bound together by standardized or proprietary technology that enables data and application portability, such as, for example, cloud bursting for load-balancing between clouds.

A cloud computing environment is service oriented with a focus on statelessness, low coupling, modularity, and semantic interoperability. At the heart of cloud computing is an infrastructure comprising a network of interconnected nodes.

With reference now to FIG. 3, a diagram illustrating a cloud computing environment is depicted in which illustrative embodiments may be implemented. In this illustrative example, cloud computing environment 300 includes a set of one or more cloud computing nodes 310 with which local computing devices used by cloud consumers, such as, for example, local computing device 320 A-N may communicate. Cloud computing nodes 310 may be, for example, server 104, server 106, client 112, and client 114 in FIG. 1. A local computing device of local computing devices 320A-320N may be, for example, client 110 in FIG. 1. Local computing devices may be stationary such as sensors and may be mobile such as vehicles, hand-carried, and body-worn/implanted.

Cloud computing nodes 310 may communicate with one another and may be grouped physically or virtually into one or more networks, such as private, community, public, or hybrid clouds as described hereinabove, or a combination thereof. This allows cloud computing environment 300 to offer infrastructure, platforms, and/or software as services for which a cloud consumer does not need to maintain resources on a local computing device, such as local computing devices 320A-N. It is understood that the types of local computing devices 320A-N are intended to be illustrative only and that cloud computing nodes 310 and cloud computing environment 300 can communicate with any type of computerized device over any type of network and/or network addressable connection using a web browser or Internet Protocol, for example.

With reference now to FIG. 4, a diagram illustrating abstraction model layers is depicted in accordance with an illustrative embodiment. The set of functional abstraction layers shown in this illustrative example may be provided by a cloud computing environment, such as cloud computing environment 300 in FIG. 3. It should be understood in advance that the components, layers, and functions shown in FIG. 4 are intended to be illustrative only and embodiments of the invention are not limited thereto. As depicted, the following layers and corresponding functions are provided.

Abstraction layers of a cloud computing environment 400 include hardware and software layer 402, virtualization layer 404, management layer 406, and workloads layer 408. Hardware and software layer 402 includes the hardware and software components of the cloud computing environment. The hardware components may include, for example, mainframes 410, RISC (Reduced Instruction Set Computer) architecture-based servers 412, servers 414, blade servers 416, storage devices 418, and networks and networking components 420. In some illustrative embodiments, software components may include, for example, network application server software 422 and database software 424.

Virtualization layer 404 provides an abstraction layer from which the following examples of virtual entities may be provided: virtual servers 426; virtual storage 428; virtual networks 430, including virtual private networks; virtual applications and operating systems 432; and virtual clients 434.

In one example, management layer 406 may provide the functions described below. Resource provisioning 436 provides dynamic procurement of computing resources and other resources, which are utilized to perform tasks within the cloud computing environment. Metering and pricing 438 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 440 provides access to the cloud computing environment for consumers and system administrators. Service level management 442 provides cloud computing resource allocation and management such that required service levels are met. Service level agreement (SLA) planning and fulfillment 444 provides pre-arrangement for, and procurement of, cloud computing resources for which a future requirement is anticipated in accordance with an SLA.

Workloads layer 408 provides examples of functionality for which the cloud computing environment may be utilized. Example workloads and functions, which may be provided by workload layer 408, may include mapping and navigation 446, software development and lifecycle management 448, virtual classroom education delivery 450, data analytics processing 452, transaction processing 454, and security management 456.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided herein relate to providing interactive content for display, the systems and methods described herein can include applied to other environments in which data included in a log database used and compared to data corresponding to previous requests for content and responsive to determining a change in the data, identifying one or more content elements to which to attribute the credit for the change. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

1. An engine power control system comprises:
a plurality of authority apparatuses;
a plurality of engine control units; and
a plurality of power level lock change file servers; and
a network communicatively coupling all the apparatuses.

2. The system of claim 1 further comprises:
at least one hierarchical object locator whereby content addressable file objects are retrievable by an access method with least latency.

3. The system of claim 2 further comprises:
at least one location and time determination service provider.

4. The system of claim 1 wherein said authority apparatus comprises:
an authority policy object store; encoded by an identity credential;
a range of date time constraints for which the authority permits each engine power level;
a range of geo-location zones within which the authority permits each engine power level;
an authentication by the authority;
a hash of the current power level lock change file;
a link to the location of supporting authority policy objects;
a message to be displayed when permission is denied; and
a link to a hash of each prior authority policy object and of each prior power level lock change file.

5. The system of claim 1 wherein said power level lock change file server comprises:
a network communication transceiver module to receive power level requests from a first engine control unit and transmit power level tokens;
an authentication module to validate the identity credential transmitted from an engine control unit (ECU);
a store of power level lock change files;
a module to determine the content addressable most recently computed engine lock change file for the engine control unit stored by an authority;
a module to retrieve each hierarchical object for the engine lock change file from each authority;
a module to generate a power level token, by logically combining the policy objects of all authorities and provide the power level token to the requesting ECU; and
a module to transmit a message to an operator user interface with the result of determining a power level token.

6. The system of claim 1 wherein said plurality of authority apparatuses comprises:
at least one maintenance policy whereby failure to log completion of scheduled service causes a power level to be lower than acceleration and climb for a location;
a recall policy whereby at least one of a recall notice and failure to record it triggers a self-executing compliance power level; and
at least one of:
insurance policy, financial terms and conditions, ownership, and
licensing validation, and restriction to geo-location policies.

7. The system of claim 1 wherein said plurality of authority servers further comprises:
a restricted geo-location boundary yaw activation space time constraint whereby power levels are overridden for engines within a glide/coast range of a restricted geo-location.

8. The system of claim 1 wherein said engine control unit comprises:
an identity credential;
a time and location determination module; and
a multi-band communications transceiver.

9. The system of claim 8 wherein said engine control unit further comprises:
a thermo-electric power module;
a power level token store; and
a power level lock change file store.

10. The system of claim 9 wherein said engine control unit further comprises:
a warmup restart module;
a processor and media; and
an operator user interface.

11. A method of operation for a system comprising the processes:
at an authority server,
receiving power level constraints and conditions for an engine control unit (ECU);
determining a power level policy which expresses the power level for the ECU;
determining a new content hash for the engine lock change file including the authority policy object;
storing the authority policy object into a plurality of distributed media;
updating the hierarchical object locator with the content hash of the authority policy object;
including the location of the previous authority policy object in the power level lock change file; and
updating the power level lock change file server with a new content hash for the ECU.

12. The method of claim 11 further comprising:
at a power level lock change file server,
receiving an updated content hash for an engine lock change file from an authority server;
storing the policy object for each authority in hierarchical object locator;
receiving a request for an updated power level token from an engine control unit;
determining an authoritative lock change file for the engine control unit;
retrieving from the hierarchical object locator the access method with least latency to the current policy object from each authority;
determining an updated power level token compliant with all of the restrictions of all the authorities;
transmitting a message with the result of the determination to an operator console; and
transmitting the updated power level token to the engine control unit.

13. A method
at an engine control unit comprising the processes:
determining a current time and location by a time and location determination module;
combining an identity credential with current time and location indicia by a processor;
reading a stored power level token from a power level token store; and
adjusting power level output to comply with current time and location wherein said power level token logically combines a range of date time constraints and a range of geo-location zones as policy objects.

14. The method of claim 13 further comprising:
transmitting to a power level lock file server a request for an updated power level token;
receiving and storing an updated power level token; and
displaying a power level status message to an operator user interface at a console, whereby an operator is informed when one of maintenance, leasing, insurance, licensing, geo-location constraints are imminent at any engine control units.

15. A system comprising:
At least one time and location determination module;
a processor;
a computer-readable storage device encoded with computer executable instructions;
at least one first engine control unit coupled to a port-side engine; and,
at least one second engine control unit coupled to a starboard-side engine, all coupled through,
a network;
wherein each of said engine control units (ECU)
comprises:
a location and time and location determination module;
an identity credential module;
a multi-band communication transceiver;
and,
a power level token store.

16. The ECU of claim 15 further comprises:
a power level token decoder;
a power level output control valve: and
an interface to an operator console.

17. The ECU of claim 16 further comprises:
an engine warmup restart module;
a thermoelectric power generator: and
a power level token request module.

18. The system of claim 15 further distinguishes at least one first engine control unit coupled to a port-side engine; from at least one second engine control unit coupled to a starboard-side engine, whereby said processor overrides the power output level in at least one engine.

19. The system of claim 15 wherein the time and location determination module determines a vector of travel direction.

20. The system of claim 15 adapted to cause a yaw force by differential power output levels applied to the port-side engine and to the starboard-side engine until the vector of travel direction avoids inertia into a restriction in geo-location, by performing computer executable instructions encoded in said computer readable storage device coupled to said processor coupled to said ECUs.
